(19) United States
(12) Patent Application Publication
(10) Pub. No.: US 2005/0289048 A1
(43) Pub. Date: Dec. 29, 2005

(54) Method, apparatus and program to offer a vehicle option contract over a network

(76) Inventor: Khai Hee Kwan, Randwick (AU)

Correspondence Address: Khai Hee Kwan, 315 Avoca St., Randwick, 2031, AU

(21) Appl. No.: 11/213,649

(22) Filed: Aug. 29, 2005

Related U.S. Application Data
(63) Continuation-in-part of application No. 10/728,222, filed on Nov. 27, 2003.
(60) Provisional application No. 60/434,819, filed on Dec. 13, 2002.
(60) Provisional application No. 60/438,090, filed on Jan. 2, 2003.

(51) Int. Cl. G06F 17/60

(52) U.S. Cl. 705/39

(57) ABSTRACT

Method, apparatus and program to offer a vehicle option. Calculation of a vehicle put option premium for a vehicle is disclosed whereby said contract provides the seller to contract selling a vehicle at the user's price of his own choosing or willingness to pay within a determined future period whereby premium in consideration of said contract provides a right but not an obligation for seller to sell to user.

### CROSS-REFERENCE TO RELATED APPLICATIONS

This application is a Continuation in Part (CIP) to application Ser. No. 10-728222 titled “Method, apparatus and program for user to determine the ownership cost of a motor vehicle” filed on 27 Nov. 2003 and incorporated herein by reference. Application Ser. No. 10-728222 also incorporates our provisional applications 60/434819 entitled “Method, apparatus and program for user to determine the ownership cost of a motor vehicle”, filed on Dec. 13, 2002, and 60/438090 entitled “ Method, apparatus and program for competitively auctioning time sharing partnerships”, filed on Jan. 2, 2003, the contents of both are also incorporated herein by reference.

### STATEMENT REGARDING FEDERAL SPONSORED RESEARCH OR DEVELOPMENT

Not Applicable

### REFERENCE TO A MICROFICHE APPENDIX

Not Applicable

### BACKGROUND OF THE INVENTION

1. Technical Field

The present invention generally relates to a business method and more particularly, to an apparatus, method, program and system for dealer/seller to offer vehicle option (put and/or call) for vehicles such as aircraft, trains, boats or ships, motor-cycles, space crafts, mobile homes, caravans and motor vehicles or generally known as transporters whether they transport humans or cargo. Obviously while this invention is designed for pricing such transporters and goods which carries a diminishing value over time. Alternatively, instead of purchasing said transporters or white goods, one can also consider rental/lease of said or alternatively services such as hotel rooms, education, tickets and rental of vehicles where their values also diminishes over time. Goods (including transporters or vehicles or online music) here refer to real properties other than a financial instrument or commodities. The invention uses financial modelling to determine the risk associated with price and uses financial option models to price the premium needed to contract a put option for the purpose of offering either by way of rental or purchase of a vehicle or transporters. Further objects being to determine a calculated mark-down price for the purpose of counter offer, to ascertain whether the price provided by potential clients (willingness to pay) are realistic and to secure the sale of the assets by enforcing a contract that will rely on specific performance as a form of relief.

2. Background to this Invention

This invention is related to our previous application Ser. No. 10-728222, in particular where the dealer has to re-purchase the vehicle from the owner at an agreed future price also known as the back-back scheme. In the above application, we described a way where the vehicle owner negotiated a buy-back fee with the seller. In this application, we provide for where the seller (dealer) decides to contract the future buyer that gives the dealer the right but not the obligation to sell to said buyer. This scenario is foreseeable given that in the event where the dealer has inventory that needs to be sold quickly and there are no ready clients to sell them given the competition. Therefore, one can see by paying the customer in the form of a mark down from the retail prices or in the form of compensation, this can be achieved or else to lock these clients to contract whereby enable the seller having the right but not obligation to sell at will to said customer. Mark down is also known as cash discount or cash back. Obviously to lock these customers into a contract consideration or compensation or mark down is needed which terms are used interchangeably. This invention calculates the consideration by way of an option formula. The consideration is also critical from a legal perspective as it provides the assistance of equity for specific performance where damages (common law remedy) is inadequate.

Furthermore as per our application Ser. No. 10-728222, we use the same option model to calculate how much mark down or consideration can be accorded to the customer. This consideration could then be adjusted to reflect the desirable amount as counter-offer price to the user. In sum, the objective in this application is to contract with the future customer such that it gives the seller the right but not obligation to sell the goods or services at the price chosen (also known as willingness to pay) by the said customer and whereby the contract is not voidable or void or repudiatable in law or equity. As mentioned, another objective is to re-use the calculated premium or consideration as a mark-down to provide a counter-offer price to the user.

### BRIEF SUMMARY OF THE INVENTION

The Inventor has developed a method of utilising a telecommunications service system host computer connecting to various terminal system including Automatic Teller Machines (ATM) which is linked to private networks or a public telephony system network or through the Internet where applicable. Obviously a wireless network is also achievable. The system consists at least a network of computer system with a multi-communication interface running on Windows NT or Unix or Linux platform with programming using Java, Visual Basic, C plus language or any suitable programming language. A database such as MS SQL or Oracle is used to store, record and updates all the contracts and transactions.

Thus according to one embodiment of the invention there is provided,

a process system comprising:

receiving an incoming request from a terminal through the public telephony system network via a modem or through the Internet or any connecting interface suitable for this purpose;

the said request information/data comprises a desired transporter and user's chosen price or willingness to pay;

respond with the put option fee as premium or consideration or mark-down calculated from the above request data and wait for a response from user;

respond with a counter offer calculated from the mark-down;

prompting the user to provide a down-payment or earnest money corresponding to a percentage of the chosen price;

and terminate transaction.

### BRIEF DESCRIPTION OF THE SEVERAL VIEWS OF THE DRAWING(S)

FIG. 1. Depicts the overall system block diagram of a preferred embodiment of the present invention.

FIG. 2. Depicts the block diagram of the central controller

FIG. 3. Depicts the block diagram of the dealer terminal and Internet connections.

FIG. 4. Depicts the input web page from a web-browser showing the variables required.

FIG. 5. Depicts the output option fee data, counter-offer and remarks.

### DESCRIPTION IN DETAIL OF THE PREFERRED EMBODIMENTS

The present invention is directed to an apparatus, program and method to determining an appropriate premium to contract transporter price in the future. We use vehicle option fee, pricing, mark-down amount, consideration and premium interchangeably. The final contract being offered in consideration of the said fee is known as a transporter option contract.

Pricing, fee or premium is calculated from a modified Black Scholes model where traditional variables are transformed to take into account the different requirements in determining the put option fee for vehicle. For example, the exercise price in the said model is now the chosen price to be paid by the potential purchaser as denoted below by X. Volatility which is measured as standard deviation is equated to the annualised standard deviation of vehicle price (normalised log) over the period and is denoted below by σ. Current price is a value for the current price of the vehicle and denoted by S. Risk Free Rate is the rate of investment in a risk free security denoted by r and time is a measured of years to delivery of vehicle and is denoted by T. Therefore according to the modified Black Scholes model as applied in this invention the is calculated using said formula;

The put option fee is calculated as:
Xe^{-rT} N(−d₂)−S N(−d₁)
where
S=current price of the transporter.
X=chosen price which the purchaser wants to purchase at, also known as the final amount payable for the transporter.
r=risk-free interest rate and σ=volatility of the transporter logarithmic price
T=time for dealer to sell the transporter to the purchaser.
N( )=area under the normal curve
   d₁=[ln(S/X)+(r+σ²/2)T]/σ T^{1/2}
   d₂=d₁−σT^{1/2}

Other option formula such as Binomial discrete model, the Black-Scholes (BS) continuous model, and their variants—and their mathematical derivations can also be used and the above is merely an example to familiarise our method. One skilled may appreciate the need to calculate a number of different period in order to get an average while using BS in recognising that the option can be exercised at any time during the period or alternatively at a set time. As noted this is only an approximation value and may be subject to heuristic rules build into the model such as profit margin, the desirability of the user, the need to sell the transporter etc. Also see Cox, J. C. and S. A. Ross (1976) The Valuation of Options Under Alternative Stochastic Processes, Journal of Financial Economics or Rubinstein, M. and J. C. Cox (1985) Option Markets, Prentice Hall, Englewood Cliffs, N.J. for general knowledge on how options work in the financial markets.

For example, say a vehicle is priced at US $ 76,000 today and it is possible within the next six to twelve months the price will fall to US $ 70,000. The strategy is to offer a vehicle put option to a potential customer who is also willing to purchase at US $ 70,000 at any time within the next 12 months. This means the dealer is given the right but not obligation to sell to this customer at US $ 70,000 at anytime within the next 12 months. Therefore how much is the price to satisfy the potential purchaser for this risk of being able sold by the dealer. Alternatively our problem is to answer what is the value of the opportunity cost being priced here sufficiently to bind the potential purchaser into the said contract.

For example using Black Scholes, say the current vehicle price is US $ 76000, the standard deviation is 30 percent, the interest rate cost (cost of free risk investment) is 10 percent, the time to sell is one year and the selling price chosen by user is US $ 70000, the put option fee is US 3493. This fee is risk money payable when the dealer fails to sell the vehicle to the potential customer as compensation. In the same way this can also be the mark-down from the vehicle price which means, the dealer would be willing to have a lower limit of US $ 72507 or (76000−3493). This allows the dealer to know a mark-down immediately and which can be used as his counter offer being US $ 72507. Obviously this mark down can be further adjusted to reflect the final counter offer, say for a particular model (3493*1.3) where 1.3 reflects the particular model being a demonstrator or marked for clearance then the mark down will be higher resulting in US $ 4540.9 or counter-offer of US $ 71459. Where there is a high demand for a particular model then the adjustment factor could be 0.9 or 1.0. It should be understood a number of adjusting factors can be built over time depending on the complexity of the system requirement. For example, based on the address provided by the user, one skilled in the art could identify a factor that shows users living in a particular suburb shown consistently a likelihood to purchase newest models hence a lower adjustment factor say 0.9 is provided. Another indicator is the user's occupation or age or gender whereby the particular vehicle is known to be popular to said occupation or age or gender. Thus these personal or profiling factors are not limiting but could be build from existing clienteles' data.

Currently there is no method known in the art to provide this instantly online whereby a customer provides a price of his own choosing and to receive a counter price calculated to meet as close as possible to his chosen price to close a deal. The system also calculates a probability of sale.

However as can be seen, this lower limit is still short of the US $ 70000 chosen by the potential purchaser (the price the purchaser is willing to pay) which means the potential purchaser has a choice of either accepting the counter offer price or enter into the put option contract at his own price and hope the vehicle will be sold at some time within the selected period at the dealer's discretion. In line with this invention, the potential purchaser is required to deposit an amount say 10% (other amounts are possible) as earnest money to contract the option contract in lieu of accepting the counter-offer price. The earnest money is to overcome the issue where potential purchaser simply put in unrealistic prices or worst for the fun of it. This earnest money as a percentage can be pre-build into the system or could be included as a direct input from the user as a choice, giving a reference point of how much interest is shown. In the example, a user who provide an earnest money equivalent to 5 percent as compare to another 10 percent, the latter would be consider to show more interest. Preferably the latter would rank ahead in the buyers queue. If this earnest money is deposited into a bank account, it provides interest say at 5 percent which is US $ 350 (based on 7000). In the event there is no sale by the end of the one year, the dealer will return the US $ 7000 plus 350 as interest plus US $ 3493 being the premium of the put option premium to lock in the potential customer. This translates in effect to offering an interest return of 49% for the money deposited to compensate the potential customer. One skilled in the art could also modify this amount by setting the max of 15% return instead of 49% and by working backwards arrive at the premium. In short, the option model provides a max upper limit which can be used later to fine tune the ‘compensatory’ amount. This is to say if over time customers find this 15% attractive then there is no reason to go for the max amount. Through trial and error, one skilled in the art in the shoes of the seller would be able to arrive at a premium suitable for his clientele matching his sell cycle. Sell cycle refers to say selling 10 vehicles a month or 5 a month depending on his target sales.

The potential customer is happy as he will receive interest on his deposit provided he is not sold the vehicle at US $ 70000 by the dealer within the one year period as per our example. The potential customer would be equally happy to be sold at US $ 70000 as this is also the same price he is willing to pay in lieu of receiving his interest cum compensation. Obviously the final price payable will be US $ 70000 less the premium.

The dealer is hedged for the period where uncertainty about a price war looms. This is to say by risking US $ 3493, the dealer is guaranteed a buyer at US $ 70000 for said vehicle. The advantage and the objective here is to be able to determine how much the potential purchasers are willing to pay for the vehicle and in real terms, the dealer will be able to consolidate a number of these offerings say from prices as low as US $ 50000 to US $ 70000 whereby he can work out the number of vehicles that he can sell depending on how many that must be sold in his inventory. The second advantage is that he will have ready clients albeit at the prices that are suitable to his clients and not necessarily for him. This means he could sell in volume to compensate this. For example, he may have 4 purchasers putting in prices at US $ 70000, 5 purchasers at US $ 68000 etc. The claimed invention provides another tool whereby this mark-down cost should be compared to his advertisement cost such that it will still make sense for him to sell at the lower price to clear his stock. The dealer will also compare his current pricing with expected pricing of his competitors when the end of the financial year sale begins for a comparable vehicle that he wish to sale. Say the dealer's usual budget for advertising is US $ 60000 per year and he manages to sell 9 vehicles at US $ 76000. Therefore, in this case, if the dealer sells 9 vehicles (5 at 70000 and 4 at 68000) given the above, he would have lost US $ 52000. A better strategy is to sell 4 vehicles at US $ 70000 and pay the remaining 5 purchasers at the put option price say US $2500 each which means he sustained a total lost of US $ 36500. The dealer has to pay the put option price or premium as he did not exercise his right to sell to the purchasers. As we mentioned, this put option price can be adjusted in accordance to variables such as interest cost and standard deviation of the vehicle's price. Furthermore, a return of US $2500 over an earnest money (10 percent) at US $ 6800 would be sufficient to attract potential purchaser to park their money with the dealer hence locking themselves in the put contracts. In the mean time, the dealer would have bought himself time to seek other potential purchasers for the next 12 months who may offer higher prices. By locking potential customers, the result is that the competitors will also lost the opportunities to sell to them. This provides a significant advantage for this system in favour to the dealer/seller. The rational is that those users who are locked into a put option contracts will not consider other offers for the fear of ending up with 2 vehicles should the original dealer exercise his right to sell. These competitors would also have to slash prices but with no advantage and could be blindly force to mark-down in order to compete. The strategy is for the dealer to pay a total of US $ 26472 (sum of all the put option premium) in order to starve his competitors off the market for the one year period.

The real benefit of this system is that the potential purchaser either gets to own the vehicle at the price of his own choosing or receive a counter price or in lieu the interest (corresponding to their earnest money) and put option premium paid to him.

In another embodiment, instead of providing the retail price of US $ 76000, the dealer could indicate a range of price say US $ 60000-80000 which allows the potential buyer to indicate his preference. The advantage of this method is that the potential buyer will have to research prices against similar vehicles in order to provide a comparative price against other potential buyers. This effectively shift the guess work to the potential buyer(s) which will provide an advantage to the dealer assuming there is no collusion between the plurality of buyers. In short, this is a tender process where the dealer will choose the highest prices offered. As we mentioned, our formula provides the mark-down price (also known as premium as calculated by option formula) in accordance to the chosen price provided by the potential buyer. In short, we reuse the said premium as the mark-down price to calculate the counter-offer price. Therefore, the lower the price chosen say US $ 60000 will return a lower mark-down to indicate the purchaser is not serious as compare to another who will put a higher price say US $ 70000 which could be meet more readily. The following Table A shows the result.

| | | Counter- | Probability of |
|---|---|---|---|
| Price Offered | Mark-Down | offer | purchase using |
| by user | (unadjusted) | Price | counter price |
| 70000 | 3493 | 72507 | 58% |
| 65000 | 2220 | 73780 | 20% |
| 60000 | 1290 | 74710 | 8% |
| 55000 | 672 | 75328 | 3.2% |

Probability of purchase by user using counter price is calculated by 1−((72507−70000)/(76000−70000)) and times 100 to get a percentage (at row 2).

Therefore the object here is to be able to calculate with certainty the mark down price personalised to the individual potential purchaser, this mark down could be offered immediately online to the potential purchaser and provide a probability of purchase by user. By observing the probability above the dealer could further adjust using heuristic rules (adjusting factors) to achieve say a probability of 67% or 72000. The object is to try to meet the price as close as possible and in the event that fails, the dealer then use the put option to lock the customer in. The current art for mark down is based purely on instinct (dealing face to face) and is subjective. Secondly, the dealer will be able to calculate the cost to lock a potential customer and thirdly, there is no prior art whereby the potential customer is provided with the opportunity to receive a return based on his earnest money being deposited to secure a vehicle purchase.

In another embodiment, the element risk-free interest rate as found in Black Scholes formula could be adjusted to reflect any commodity's return rate such as quoted oil, gold, index, stocks etc (not limiting to risk free interest rate) assuming the dealer will invest the money in such a commodity or derivative of such. This rate is merely to use to identify the cost of compensation (ie cost of borrowing risk free Vs Investment rate) and hence could be applied in accordance to how the investment strategy to better the return.

In another embodiment, the potential buyer could apply the teaching in our provisional 60/438090 to incorporate time sharing (time-shared) for the vehicle by means of aggregating the various interest with other time sharers to submit in part the chosen price. Should the vehicle be sold to the purchaser then it is on a time sharing basis with other sharers.

In yet another embodiment, instead of purchasing the vehicle, the user could merely rent or lease the vehicle or for that matter a hotel room, building or property. The underlying technology is designed to interactively close the deal or to lock in the user for a pre-determined period. Interactively refers to calculating by reusing the calculated option premium, a range of counter prices build from unadjusted mark-down followed by adjusted mark-down and presenting them in response to the user's action For example, US $ 72507 and US $ 71459 from above purchase example are selected here and the first counter offer is US $ 72507. The system could also use the probabilities as a threshold to decide whether counter-offers will be output or not. In Table A above, we could apply the cut-off mark at above 50% which means there is only one unadjusted counter offer of US $ 72507 followed by another adjusted counter offer based on personal factors of the user. In short, user submitting in row 3 will not be entertained as it is below cut-off mark.

If there is no response from the user within 10 mins or detecting the user has closed the webpage or move on to another webpage or website, the system could then respond with the second counter offer of US $71459 either by way of a pop up window or chat window or by voice or other means including through a second telecommunication network (say mobile phone) to draw the user's attention to this new counter-offer over the network. While this could be executed by a human say through a chat channel, the system is designed to be automated and a program can be designed to mimic as if a human is responding. For example, a text message can be send saying “OK, you got me, my final offer is US $ 71459, my boss will kill me if he found out but for you this is my best, you will not get a better deal else where. Click here to accept now and I will even throw in a free air-conditioner” Obviously interactive voice response or recognition system could also be employed.

As mentioned, this application is also applicable where these goods show a diminishing return over its useful life. For example, a hotel room if not rented out will mean there is no income hence the difficulty remains what is the optimum price which could be agreed in order to mitigate the loss. Most importantly, it provides an opportunity for the renter to close the deal with a counter-offer which is the preferred option and if this fails then to lock the user using a put option. Therefore our application is well suited to capture the interest of a potential user by first inviting the user to provide a price he is willing to pay and next by providing a counter offer(s) or else to provide a put option contract whereby the renter has the right but not obligation to rent it within a period of time or by default pay the user a compensatory amount.

In contrast to prior arts such as Conditional Purchase Offer (CPO) by Walker et al (U.S. Pat. No. 6,085,169), a CPO is not created by means of calculation but is only a conditional offer to a seller by a buyer wherein the condition being a predefined price to purchase a service or goods subject to other rules set by the seller in acceptance to the CPO. The seller has obligation to sell once these rules are satisfied as these are not optional. The problem with CPO is that there is no consideration as calculated as per our option formula as found in the premium to compensate the potential purchaser in the event of no sale. This consideration is critical as it forms the basis under the law of contract to successfully enforce a contract. No consideration means legally the contract is void and the CPO is not enforceable. Furthermore, equity will not assist a volunteer (ie without consideration) to seek specific performance when damages are not adequate.

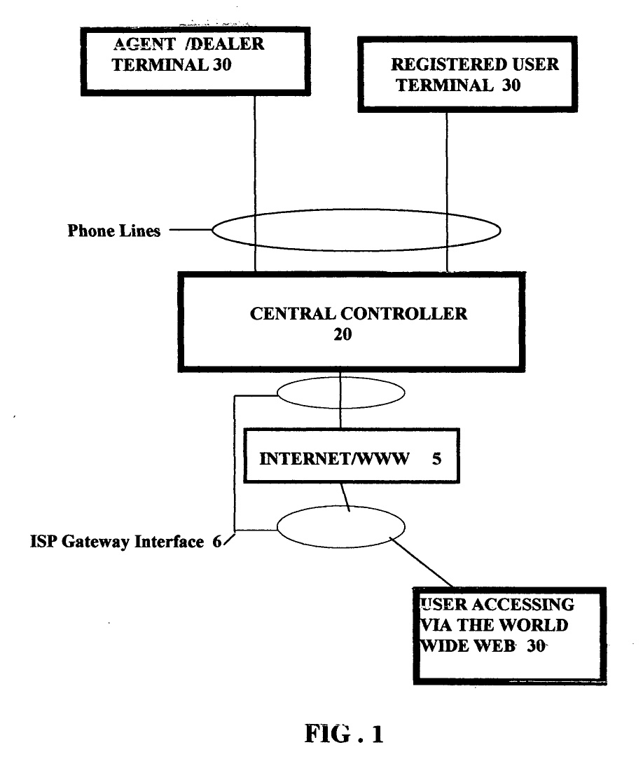

FIG. 1 is an overall system block diagram of a preferred embodiment of the present invention. In this embodiment, central controller 20 is linked up to at least one dealer terminal 30 or registered user 30. The central controller 20 is where the software for this invention is stored but said software can also be stored singularly in the dealer terminal which means this is a standalone without any link to an external controller 20. Where there is a link, this linked can also be through the Internet through the Internet Service Provider (ISP) Gateway 6 or a network system with hypermedia capabilities whichever is preferable by the seller/provider at that time depending on economic costs of the system. Three terminals are depicted in FIG. 1 but any number of terminals can be used including those linked via the Internet 5. The link between the terminal 30 and the central controller 20 does not have to be a physical link it can, for example be a link via a modem, as described in the subsequent description, or any other telecommunication link including wireless systems.

A request can be initiated from any one of the dealer/users terminals 30. The information required to implement the transaction is passed until the transaction is complete. The central controller 20 keeps track of all transactions including transactions in the system and whereby the software necessary to calculate the premium and discount is executed. The system depicted in FIG. 1 may be embodied in hardware specially provided to implement the present invention. Alternatively, the system may be implemented using existing infrastructure such as the Internet via an ISP Gateway 6 interface. The preferable protocol is TCP/IP although other protocols such as wireless can be used.

The hardware and communication links may be change to incorporate this invention such as by way of reprogramming an existing server or by adding an additional file server (with or without a CPU dedicated to the transactions). Alternatively, the subject invention can be implemented by using existing hardware and software entirely by making appropriate software updates.

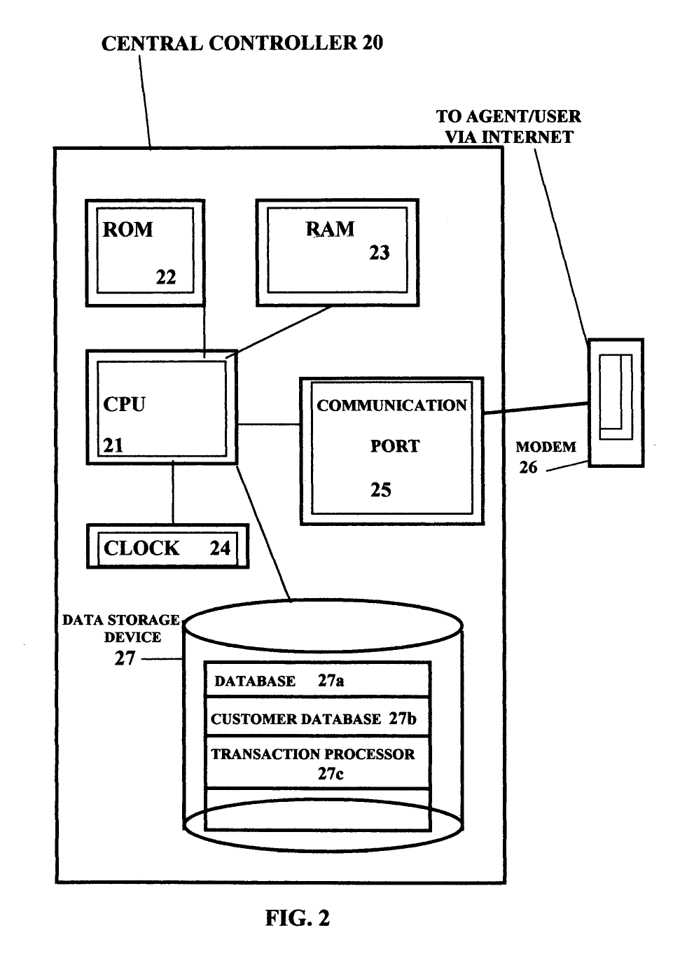

FIG. 2 is a block diagram of a preferred central controller 20. The central controller includes a CPU 21 which performs the processing functions of the controller. It is also includes a read only memory 22 (ROM) and a random access memory 23 (RAM). The ROM 22 is used to store at least some of the program instructions that are executed by the CPU 21 such as portions of the operating system or BIOS or a program and the RAM 23 is used for temporary storage of data. A clock circuit 24 provides a clock signal which is required by the CPU 21. The use of a CPU 21 in conjunction with ROM and RAM and a clock circuit is accepted to those skilled in the design of the CPU based electronic circuit design. The central controller 20 also includes a communication port 25 which enables the CPU 21 to communicate with devices external to the central controller 20. In particular the communication port 25 facilitates communication between the modem 26 and the CPU 21, so that information arriving from the modem 26 can be processed by the CPU 21 and the CPU 21 can send information to remote location via the modem 26.

While the illustrated embodiment uses a modem for communicating with devices outside the central controller, it should be understood readily that other methods of communicating with external devices may be used instead of the modem. These other methods include hard-wired connections, wireless such as radio frequencies, fibre optic lines, network card etc.

The CPU 21 can also store information to and read information from, the data storage device 27. This data storage device 27 includes a transaction database 27a and a customer database 27b, which are described below. In addition, it includes transaction processor instruction 27c which can be read by and executed by the CPU 21, thereby enabling the CPU 21 to process transactions. While FIG. 2 depicts separate transaction and customer databases, a single database that incorporates both of those functions may be used.

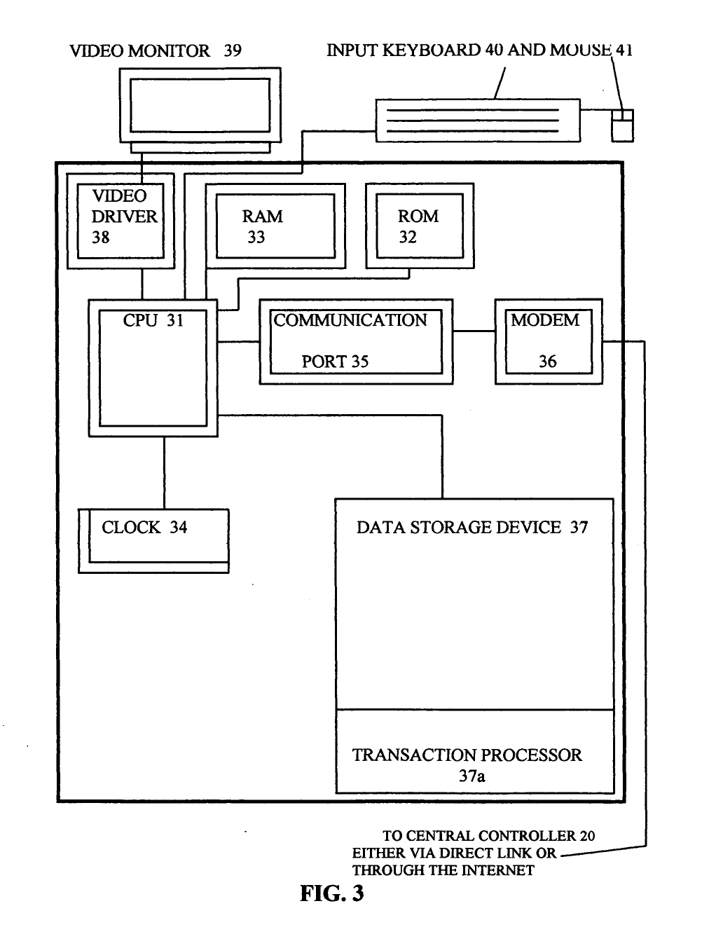

FIG. 3 is a block diagram of a preferred user terminal which can be located at a dealer's office or private home, or any establishment having the authority to lend itself to this network. The network can be a distributed hypermedia environment. As discussed there can be a number of dealer terminals 30 linked to the one central controller 20. Like the central controller describe above, the dealer terminal 30 includes a CPU 31, ROM 32, RAM 33 and a clock circuit 34. The dealer terminal 30 also include a communication port which interfaces with a modem 36 that facilitates communication between the dealer terminal 30 and the central controller 20. Of course instead of a modem 36 other communication devices can be used as shown above for the central controller 20. A standard computer such as an IBM PC, Apple Macintosh, running appropriate custom designed software may be used as the dealer terminal.

The dealer terminal 30 also includes an input device 40 to receive input from an operator or user. Any of a wide variety of input devices would be suitable including touch screen, mouse 41, keyboard 40. The input device 40 may interface directly with the CPU 31 as shown in the figure. Alternatively an appropriate interface circuit may be placed between the CPU 31 and the input device 40.

The dealer terminal 30 also includes a video monitor 39 for conveying information to the operator. While the most preferred video monitor 39 is a CRT, other video display devices including LCD, LED and thin film transistor panels, may be used as well. A video driver 38 interfaces the CPU 31 to the video monitor 39 (or to any other type of video display device). The dealer terminal 30 also includes a data storage device 37 in which transaction processor instructions 37a are stored. These instructions can be read by and executed by the CPU 31 thereby enabling the CPU 31 to process transactions. Typically the dealer terminal will run a browser type of software which enables it to access information via the Internet 5 and onwards to the central controller 20.

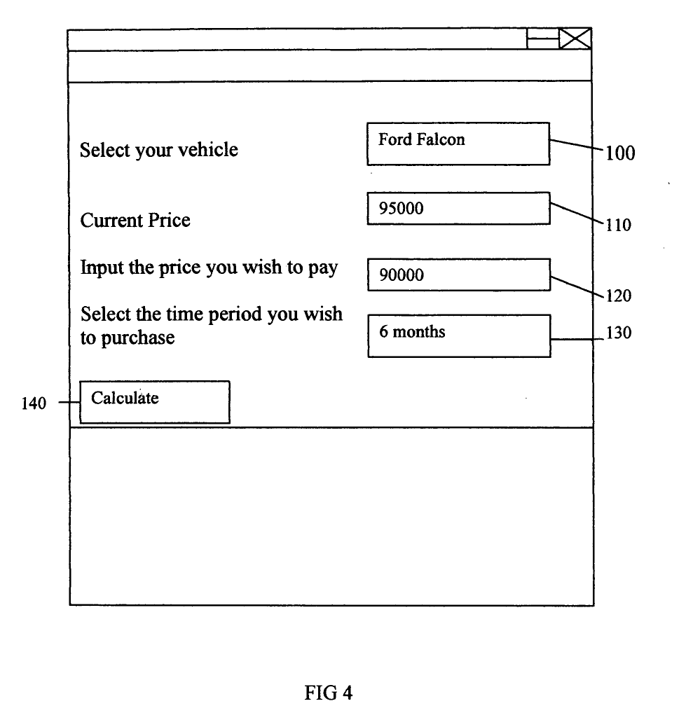

FIG. 4 is a depiction of the web page found in a web browser where the user or potential purchaser could input the necessary data in order to determine the option premium that he could receive or alternatively to indicate the price he wish to pay.

The steps of the process shown in FIG. 4 may be implemented in a computer program that may be installed at the dealer terminal or remotely on the central controller 20. For example a computer readable medium (such as a floppy disks or CD-ROMs) which is then stored in memory, in this case the data storage device 37 (Shown in FIG. 3). Alternatively, although not so describe below, the computer program be installed at the central controller 20 from a computer readable medium and then stored therein in one or more of the ROM memory 22, RAM memory 23 and data storage device 27 for access and use by dealer terminals 30 as required.

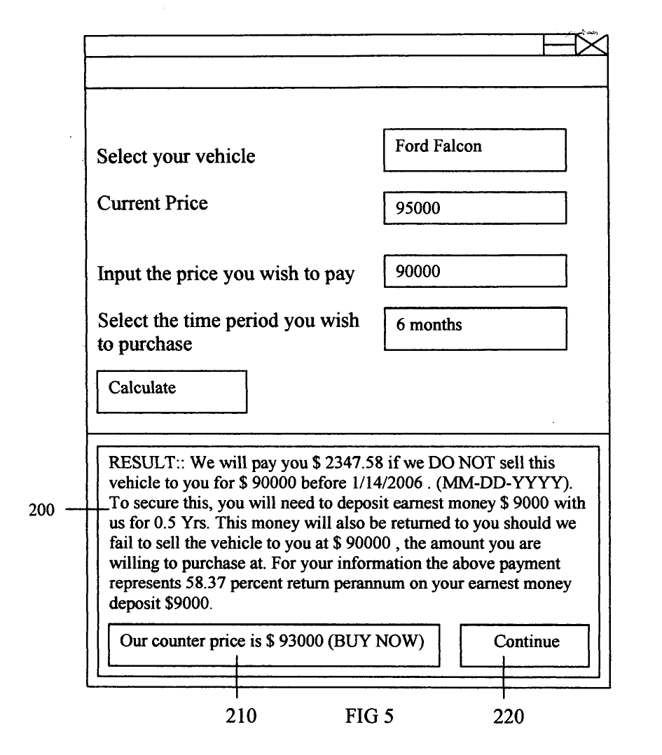

The process starts when a customer contacts a vehicle dealer's website and see a web page as found in FIG. 4. Alternatively, a registered user can access it through the ISP Gateway 6 via the internet by using browser programs by applying the command http://www.vehicleoption.com which connects to the central controller 20. Where possible mirror sites are available for faster access. The customer is provided with a menu and input vehicle information. This information is fairly basic and includes the vehicle model (in this case a motor vehicle) as seen in box 100. Typically, this would be a drop down menu where a plurality of vehicles are shown and the user can select the one that he is interested in. Other features such as a photo of the vehicle could pop up as well designed using flash files which is well within the skill of one in the art of web designing. Upon selection, the current price at box 110 is revealed to show the current price offered by the dealer. Similarly, the dealer could also use a comparison box to show other prices offered by his competitors. In box 120, the user will input his desired (chosen) price for the vehicle whereby he is willing to pay for. In this case, we have inputted the value 90000. Box 130 shows the time period where he is willing to be locked in which is 6 months. This period will give the dealer 6 months whereby he has the rights but not the obligation to sell the vehicle to the potential purchaser. In box 140, the user can click the button to calculate the value which is shown in FIG. 5. The inputted values will then be transmitted to the central controller 20. The input and calculation process shown in FIG. 4 may be implemented in a computer program that may be installed in the central controller 20 from a computer readable medium and then stored therein in one or more of the ROM 22 and RAM 23 and the data storage device 27 (shown in FIG. 2).

FIG. 5 shows mainly the calculated values being returned from central controller 20 to a webpage. FIG. 5 is similar to FIG. 4 except for box 200 where the system provides the result to the user's input In this case, the dealer will pay US $ 2347.58 if they do not sell the vehicle to the purchaser within 6 months which is Jan. 14, 2006 (assuming the contract begins on Jul. 14, 2005). The user then has the option to continue to contract by pressing box 220 or to accept adjusted counter offer price (using 2000 instead of actual calculated 2347.58 as mark down whereby the difference reflect another heuristic rule (or personal factors) to persevere a profit margin 15%) by pressing box 210 or to revise the inputs above as mentioned in FIG. 4. If the user continues then he will provide his address and personal data which are then updated into a database (27b in FIG. 2). At the conclusion, the user will be provided with a contract to be printed out to secure this agreement. Preferably, the instructions in the contract will be for the user to deposit the earnest money as soon as practicable in order for the contract to be executed.

Having thus described our invention, what we claim as new and desire to secure by Letters Patent is set forth in the following claims. While the present invention has been described above in terms of specific embodiments, it is to be understood that the invention is not limited to the disclosed embodiments. On the contrary, the present invention is intended for various modifications and equivalent structures (such as distributed hypermedia environment) included within the spirit and scope of the appended claims.

1. A method for determining transporter option premium over a network connected to a central controller and a plurality of terminals, comprising the steps:
receiving transporter pricing information from user relative to the future purchase of a transporter;
calculating the transporter put option premium;
outputting the transporter put option premium to the user for decision; and
whereby the said put option provides the seller the right but not obligation to sell the transporter to user.

2. The method according to claim 1, whereby transporter pricing information comprising at least one of the first information concerning period to purchase, second information concerning price chosen by user.

3. The method according to claim 1, wherein calculating step the transporter put option is based at least in part on a financial option formula.

4. The method according to claim 1, further comprising the steps of:
using the said calculated put option premium as a mark down price;
calculating the counter offer price;
calculating the probability of user accepting the counter offer; and
outputting the counter offer price.

5. The method according to claim 1, further comprising the steps of:
receiving an indication that a user has accepted the transporter option;
receiving earnest money from user; and
updating a customer database to record the contracted transporter option.

6. The method according to claim 1, whereby said transporter pricing
information is secured on a time-shared basis.

7. A computer program product for use in a system having at least one client workstation and one network server coupled to said network environment, wherein said network environment is a distributed hypermedia environment, the computer program product comprising:
a computer usable medium having computer readable program code physically embodied therein, said computer program product further comprising:
computer readable program code implementing the method of claim 1

8. A computer program product for use in a system having at least one client workstation and one network server coupled to said network environment, wherein said network environment is a distributed hypermedia environment, the computer program product comprising:
a computer usable medium having computer readable program code physically embodied therein, said computer program product further comprising:
computer readable program code implementing the method of claim 2

9. A computer program product for use in a system having at least one client workstation and one network server coupled to said network environment, wherein said network environment is a distributed hypermedia environment, the computer program product comprising:
a computer usable medium having computer readable program code physically embodied therein, said computer program product further comprising:
computer readable program code implementing the method of claim 3

10. A computer program product for use in a system having at least one client workstation and one network server coupled to said network environment, wherein said network environment is a distributed hypermedia environment, the computer program product comprising:
a computer usable medium having computer readable program code physically embodied therein, said computer program product further comprising:
computer readable program code implementing the method of claim 4

11. A computer program product for use in a system having at least one client workstation and one network server coupled to said network environment, wherein said network environment is a distributed hypermedia environment, the computer program product comprising:
a computer usable medium having computer readable program code physically embodied therein, said computer program product further comprising:
computer readable program code implementing the method of claim 5.

12. A computer program product for use in a system having at least one client workstation and one network server coupled to said network environment, wherein said network environment is a distributed hypermedia environment, the computer program product comprising:
a computer usable medium having computer readable program code physically embodied therein, said computer program product further comprising:
computer readable program code implementing the method of claim 6.

13. A computer system having at least one client workstation and one network server coupled to said network environment, wherein said network environment is a distributed hypermedia environment, the computer implementing the method of claim 1.

14. A computer system having at least one client workstation and one network server coupled to said network environment, wherein said network environment is a distributed hypermedia environment, the computer implementing the method of claim 2.

15. A computer system having at least one client workstation and one network server coupled to said network environment, wherein said network environment is a distributed hypermedia environment, the computer implementing the method of claim 3.

16. A computer system having at least one client workstation and one network server coupled to said network environment, wherein said network environment is a distributed hypermedia environment, the computer implementing the method of claim 4.

17. A computer system having at least one client workstation and one network server coupled to said network environment, wherein said network environment is a distributed hypermedia environment, the computer implementing the method of claim 5.

18. A computer system having at least one client workstation and one network server coupled to said network environment, wherein said network environment is a distributed hypermedia environment, the computer implementing the method of claim 6.

19. Computer executable software code stored on a computer readable medium, the code for user to obtain the premium to contract the price a user is willing to pay for a good or services having a diminishing value and paying for said price within a determined future period, comprising:
code to receive information representative of the period for the contract;
code to receive information representative of current cost of the selected goods or services;
code to receive information representative of a investment rate;
code to receive information representative of the standard deviation of the cost of the selected goods or services;
code to receive information representative of the willingness of user to pay for said goods or services;
code to obtain a premium to contract said asset by applying an option pricing model using in part said standard deviation information, said user's willingness to pay and said investment rate;
code to apply said premium as a mark-down price to obtain the counter-offer price;
wherein said contract is a purchase, lease or rental contract; and
wherein said goods are neither a financial instrument nor commodities.

20. The computer executable software code according to claim 19 wherein said pricing model is in part a derivative pricing model.
